(19) United States
(12) Patent Application Publication
(10) Pub. No.: US 2014/0186531 A1
(43) Pub. Date: Jul. 3, 2014

(54) Compositions For Generating On-Demand Dry-Erase Writing Surfaces, Fluid Applicators Containing Same, And Methods

(71) Applicant: SANFORD, L.P., Oak Brook, IL (US)

(72) Inventors: Wing Sum Vincent Kwan, Chicago, IL (US); Xiaomang Wang, Lake Bluff, IL (US)

(73) Assignee: SANFORD, L.P., Oak Brook, IL (US)

(21) Appl. No.: 14/145,563

(22) Filed: Dec. 31, 2013

Related U.S. Application Data
(60) Provisional application No. 61/747,910, filed on Dec. 31, 2012.

(51) Int. Cl. C09D 1/04; B43K 1/00; B43K 1/01

(52) U.S. Cl. CPC C09D 1/04; B43K 1/01; B43K 1/006
USPC 427/260; 106/32.5; 427/397.8; 401/196

(57) ABSTRACT

The invention relates generally to compositions for generating ‘on-demand’ dry-erase writing surfaces, fluid applicators for applying same to a supporting surface, and methods of generating same and methods of making dry-erase written markings on the same.

### FIELD OF THE INVENTION

The invention relates generally to dry-erase writing surfaces and more particularly to compositions for generating ‘on-demand’ dry-erase writing surfaces, fluid applicators for applying same to a supporting substrate, and methods of generating ‘on-demand’ dry-erase writing surfaces and making dry-erase markings on the same.

### BRIEF DESCRIPTION OF RELATED TECHNOLOGY

Dry-erase writing surfaces or white boards are well-known. A typical dry-erase writing surface (“white board”) includes a white board or substrate that is coated with a relatively non-porous surface such as an enamel, film, coating, or porcelain finish. White boards are typically provided in classrooms and conference rooms as chalk board substitutes and in homes as discrete note pad sized boards that facilitate messaging, reminders, lists, and the like. Specially designed markers “dry-erase” markers are employed to write on the white boards. While the ink of the marker dries on the substrate, the ink does not bond to the substrate surface and the writing can be easily removed with a soft eraser, cloth, finger, and the like.

### DETAILED DESCRIPTION

The invention advantageously provides compositions for generating ‘on-demand’ dry-erase writing surfaces. Using the compositions, fluid applicators, and methods according to the invention, a consumer can easily and quickly adapt any supporting substrate for use as a dry-erase writing surface that can be temporarily used to facilitate messaging, reminders, lists, and the like while concurrently providing protection and stain resistance against (permanent) unwanted written marks. Beneficially, both porous and non-porous supporting substrates can be quickly and easily adapted for use as dry-erase writing surfaces using the compositions, fluid applicators, and methods according to the invention.

Examples of suitable soluble compounds for use in the compositions for generating ‘on-demand’ dry-erase writing surfaces can be classified as inorganic compounds that include an element from one or more of groups 2b, 3a, and 4a-b of the periodic table, preferably an element such as silicon, zinc, aluminum, or titanium. In one embodiment, a composition for generating ‘on-demand’ dry-erase writing surfaces comprises a solvent and a soluble compound selected from oxides, silicates, zincates, aluminates, titanates, and mixtures thereof, which soluble compound is soluble in the solvent.

Examples of silicates include metal silicates, preferably, alkali metal silicates. A preferred example of a silicate is a water-soluble silicate. An example of a water-soluble metal silicate is potassium silicate, e.g., the potassium salt of silicic acid. An additional example is sodium silicate, e.g., the sodium salt of silicic acid. Suitable water-soluble potassium silicates are sold under the trade name KASIL™ silicates (PQ Corporation, Malvern, Pa.). A specific commercially available example of potassium silicate solution is KASIL® 2130 potassium silicate solution (PQ Corporation, Malvern, Pa.). Suitable water-soluble sodium silicates are sold under the trade name STAR™ silicates (PQ Corporation, Malvern, Pa.) and under the trade name UNIFLO™ (Occidental Chemical Corp., Tex.). A specific commercially available example of sodium silicate solution is N® 38 sodium silicate solution (PQ Corporation, Malvern, Pa.). Sodium silicate is the common name for a compounds with the formula Na₂(SiO₂)ₙO. Sodium silicate is typically a white powder that is readily soluble in water, producing an alkaline solution. A well known member of this series is sodium metasilicate, Na₂SiO₃. Other members include sodium orthosilicate, Na₄SiO₄, sodium pyrosilicate, Na₆Si₂O₇, and others. All are glassy and dissolve in water. Suitable sodium metasilicates are sold under the trade name UNIFLO™ (Occidental Chemical Corp., Tex.). Sodium orthosilicates and sodium pyrosilicates may also be used.

A preferred example of a zincate is a water-soluble basic zincate. Solubilized zinc oxide may be used. A zinc oxide solution can be prepared by dissolving zinc oxide powder in an alkaline solution, e.g., ammonia or sodium hydroxide solution. A solubilized form of zinc oxide is commercially available as zinc oxide solution #1 (BASF Corp.).

A preferred example of an aluminate is a water-soluble basic aluminate. A solubilized aluminum oxide can be prepared by dissolving aluminum oxide or hydroxide in an alkaline solution, preferably in an excess of alkaline solution, for example, ammonium hydroxide or sodium hydroxide solution. An aluminate solution is obtained.

A preferred example of a titanate is a solvent-soluble titanate. Examples of titanates include titanium alkoxides, titanium alkanedionates, titanium lactates, titanium aminoalkoxides, and combinations thereof. Examples of suitable titanium alkoxides include titanium (IV) ethoxide and the titanates sold under the TYZOR™ trade name (DuPont Chemical Co.). Further examples of titanates include esters of titanium dioxide, e.g., an organic orthoester.

In one aspect of this embodiment, the composition for generating ‘on-demand’ dry-erase writing surfaces may further comprise a pH indicator which changes color from colored to colorless as the composition dries (after application to a supporting substrate) to form the on-demand dry-erase writing surface. Suitable pH indicators for use in the compositions for generating ‘on-demand’ dry-erase writing surfaces include but are not limited to o-cresolphthalein, phenolphthalein, thymolphthalein, m-nitrophenol, p-nitrophenol, cyanine, bis-(2,4-dinitro-phenyl)acetic acid ethyl ester, and mixtures thereof.

For regulatory reasons, the solvent of the composition for generating ‘on-demand’ dry-erase writing surfaces is preferably aqueous. Suitable water-soluble compounds for use in the compositions for generating ‘on-demand’ dry-erase writing surfaces include but are not limited to water soluble compounds selected from oxides, silicates, zincates, aluminates, and mixtures thereof. For example, the water-soluble compound can be selected from the group consisting of zinc oxide, metasilicates, pyrosilicates, orthosilicates, aluminum oxides, aluminum hydroxides, and mixtures thereof. Such aqueous compositions for generating ‘on-demand’ dry-erase writing surfaces can also advantageously include a pH indicator so as to provide an easily discernable visual indicator indicating when the composition has dried sufficiently so as to provide an on-demand dry-erase writing surface that is ready to receive written markings. One preferred water-soluble compound is sodium silicate.

When a faster dry time is desired, it can be advantageous to use an organic solvent in the compositions for generating ‘on-demand’ dry-erase writing surfaces. Suitable organic solvents include hydrocarbons and halo-substituted hydrocarbons. Exemplary hydrocarbons include volatile branched chain hydrocarbons having from about 4 to about 30 carbon atoms, or from about 4 to about 20 carbon atoms, or preferably from about 6 to about 20 carbon atoms. Such hydrocarbons include, for example, isoparaffins commercially available from Exxon Chemical Company (Baytown, Tex. U.S.A.), as Isopar M (C13-C14 Isoparaffin), Isopar C (C7-C8 Isoparaffin), Isopar E (C8-C9 Isoparaffin), Isopar G (C10-C11 Isoparaffin), Isopar L (C11-C13 Isoparaffin), Isopar H (C11-C12 Isoparaffin). Other non-limiting examples of suitable branched chain hydrocarbons are commercially available from Presperse, Inc. (South Plainfield, N.J.) as Permethyl 99A (isododecane), Permethyl 102A (isoeicosane), and Permethyl 101A (isohexadecane). Other non-limiting examples of suitable branched chain hydrocarbons include petroleum distillates such as those available from Phillips Chemical as Soltrol 130, Soltrol 170, and those available from Shell as Shell Sol 70, Shell Sol 71, and Shell Sol 2033. Additional suitable hydrocarbons include dodecane, octane, decane, hydrogenated polyisobutanes and combinations thereof. For example, the Norpar series of paraffins available from Exxon Chemical Company such as Norpar 12, Norpar 13, and Norpar 15 can be used as the carrier solvent. Yet another example includes C11-C15 alkanes/cycloalkanes, such as those available from Exxon as ExxSol™ D80. Suitable organic solvent soluble compounds include but are not limited to titanates selected from the group consisting of titanium alkoxides, titanium alkanedionates, titanium lactates, titanium aminoalkoxides, and mixtures thereof.

In order to provide better adhesion to a surface, the compositions for generating ‘on-demand’ dry-erase writing surfaces may further comprise a resin and/or a silane. For example, the composition for generating ‘on-demand’ dry-erase writing surfaces may further comprise a silane selected from the group consisting of amino-functional silanes, alkyl-functional silanes, epoxy-functional silanes, fluoroalkyl-functional silanes, vinyl-functional silanes. Suitable amino functional silanes are available under the DYNASYLAN® trade name (Evonik Industries).

The invention also provides fluid applicators comprising a housing including a fluid and an application element for dispensing the fluid, the fluid comprising a composition for generating an on-demand dry erase writing surface according to the invention as described herein.

Any known fluid applicator can be used. Markers comprised of an ink reservoir (whether a fibrous reservoir or a so-called free ink reservoir) for storing the on-demand dry erase writing composition and a nib in fluid communication with the ink reservoir are well known and can be used for dispensing fluid compositions for generating ‘on-demand’ dry-erase writing surfaces according to the invention. Bottles including a cap for sealing the bottle, the cap including an applicator such as a plurality of brush bristles or a foam wedge attached to an end of a stem projecting from an underside of the cap are also well known and can be used for dispensing fluid compositions for generating ‘on-demand’ dry-erase writing surfaces according to the invention. Spray cans including a nozzle in fluid communication with the spray can contents are also well known and can be used for dispensing fluid compositions for generating ‘on-demand’ dry-erase writing surfaces according to the invention. The thickness of the deposited coating (and hence the generated on-demand dry erase writing surface) can be controlled via fluid viscosity and the number of applied coats.

Thus, the invention also provides methods of generating on-demand dry-erase surfaces. According to the methods, a fluid applicator including a composition for generating ‘on-demand’ dry-erase writing surfaces is provided, the fluid applicator is actuated to dispense the fluid composition on a surface of a supporting substrate, and the fluid composition is allowed to dry to provide an on-demand dry erase surface. As mentioned previously, when the composition or generating ‘on-demand’ dry-erase writing surfaces is aqueous, a pH indicator can be included so as to provide an easily discernable visual indicator indicating when the composition has dried sufficiently so as to provide an on-demand dry-erase writing surface that is ready to receive written markings.

Advantageously, upon drying, the generated on-demand dry erase surface can then be used by consumers. Thus, the methods may further comprise (i) providing a dry erase capillary action marker comprised of an ink reservoir and a porous nib, the ink reservoir containing a dry-erase ink composition and, optionally, (ii) contacting the nib of the capillary-action marker to the on-demand dry erase surface to make a written mark on the dry erase surface. In addition, the method may further comprise erasing the written mark previously made by the consumer.

Alternatively, the compositions for generating ‘on-demand’ dry-erase writing surfaces disclosed herein can be deposited using other film deposition methods including but not limited to dip-coating, flexo-printing, gravure printing, offset printing, inkjet printing, stamping, spraying, brushing, rolling, puffing, and the like.

The compositions for generating ‘on-demand’ dry-erase writing surfaces disclosed herein, the fluid applicators for applying same to a supporting substrate, and methods of generating ‘on-demand’ dry-erase writing surfaces and making dry-erase markings on the same can be better understood in light of the following examples, which are merely intended to illustrate the compositions and are not meant to limit the scope thereof in any way.

### EXAMPLES

Compositions for generating ‘on-demand’ dry-erase writing surfaces were prepared with the ingredients identified in below in the amounts shown. The compositions were applied to a supporting substrate surface to provide ‘on-demand’ dry-erase writing surfaces. Written marks were applied to the generated dry-erase writing surfaces using EXPO® dry-erase markers available from Newell Rubbermaid Office Products (Oakbrook, Ill.). The ‘on-demand’ dry-erase writing surfaces received and presented the subsequently applied written marks clearly. In addition, the written marks were removed easily and thus the ‘on-demand’ dry-erase writing surfaces demonstrated good protection and stain resistance against (permanent) unwanted written marks.

| | | | Compo- | Compo- |
|---|---|---|---|---|
| Description | Composition 1 | Composition 2 | sition 3 | sition 4 |
| D.I.Water | | | 10.00% | 9.99% |
| KASIL ® 2130 | 100.00% | | | |
| (potassium | | | | |
| silicate solution) | | | | |
| N ® 38 | | 100.00% | 90.00% | 90.00% |
| (sodium | | | | |
| silicate solution) | | | | |
| o-Cresolphthalein | | | | 0.01% |
| Viscosity | 6.90 | 44.50 | 15.90 | 15.80 |

1. A fluid applicator comprising:
a housing including a fluid; and
an application element for dispensing the fluid, the fluid comprising a solvent and a soluble compound selected from oxides, silicates, zincates, aluminates, titanates, and mixtures thereof, wherein said soluble compound is soluble in the solvent.

2. The fluid applicator according to claim 1, the fluid further comprising a pH indicator.

3. The fluid applicator according to claim 2, wherein the pH indicator is selected from the group consisting of o-cresolphthalein, phenolphthalein, thymolphthalein, m-nitrophenol, p-nitrophenol, cyanine, bis-(2,4-dinitro-phenyl)acetic acid ethyl ester, and mixtures thereof.

4. The fluid applicator according to claim 1, wherein the solvent is aqueous and the soluble compound is a water-soluble compound selected from oxides, silicates, zincates, aluminates, and mixtures thereof.

5. The fluid applicator according to claim 4, wherein the water-soluble compound is selected from the group consisting of zinc oxide, metasilicates, pyrosilicates, orthosilicates, aluminum oxides, aluminum hydroxides, and mixtures thereof.

6. The fluid applicator according to claim 1, wherein the solvent is aqueous and the soluble compound is a water-soluble compound comprising at least one alkali metal silicate.

7. The fluid applicator according to claim 4, wherein the water-soluble compound is sodium silicate.

8. The fluid applicator according to claim 1, wherein the solvent is an organic solvent and the soluble compound is a titanate selected from the group consisting of titanium alkoxides, titanium alkanedionates, titanium lactates, titanium aminoalkoxides, and mixtures thereof.

9. The fluid applicator according to claim 1, the fluid further comprising a resin and/or a silane.

10. The fluid applicator according to claim 8, wherein the fluid further comprises a silane selected from the group consisting of amino-functional silanes, alkyl-functional silanes, epoxy-functional silanes, fluoroalkyl-functional silanes, vinyl-functional silanes.

11. The fluid applicator according to claim 1, wherein the fluid applicator is selected from the group consisting of a marker, a bottle including an application element coupled thereto, and a spray can.

12. A method of generating an on-demand dry-erase surface, the method comprising:
providing a fluid applicator according to claim 1;
dispensing the fluid on a supporting substrate;
allowing the fluid to dry to provide an on-demand dry erase surface on the supporting substrate.

13. The method of claim 12, further comprising, after the fluid has dried, providing a dry erase capillary action marker comprised of an ink reservoir and a porous nib, the ink reservoir containing a dry-erase ink composition, and contacting the nib of the capillary-action marker to the on-demand dry erase surface to make a written mark.

14. The method of claim 13, further comprising erasing the written mark.

15. A composition for generating an on-demand dry erase surface comprising:
a solvent; and
a soluble compound selected from oxides, silicates, zincates, aluminates, titanates, and mixtures thereof, wherein said soluble compound is soluble in the solvent, the composition further comprising a pH indicator.

16. (canceled)

17. The composition according to claim 15, wherein the pH indicator is selected from the group consisting of o-cresolphthalein, phenolphthalein, thymolphthalein, m-nitrophenol, p-nitrophenol, cyanine, bis-(2,4-dinitro-phenyl)acetic acid ethyl ester, and mixtures thereof.

18. The composition according to claim 15, wherein the solvent is aqueous and the soluble compound is a water-soluble compound selected from oxides, silicates, zincates, aluminates, and mixtures thereof.

19. (canceled)

20. The composition according to claim 18, wherein the water-soluble compound is sodium silicate.

21. (canceled)

22. The composition according to claim 15, further comprising a resin and/or a silane.

23. (canceled)

24. A kit including a fluid applicator according to claim 1 and a dry erase capillary action marker comprised of an ink reservoir and a porous nib, the ink reservoir containing a dry-erase ink composition.
